(19) United States
(12) Patent Application Publication
(10) Pub. No.: US 2026/0037861 A1
(43) Pub. Date: Feb. 5, 2026

(54) ACTIVE ADAPTIVE ON-DEVICE MACHINE LEARNING

(71) Applicant: Dell Products L.P., Round Rock, TX (US)

(72) Inventors: Renam Castro da Silva, São José dos Campos (BR); Victor da Cruz Ferreira, Rio de Janeiro (BR); Jonathan Mendes De Almeida, Brasília (BR)

(73) Assignee: Dell Products L.P., Round Rock, TX (US)

(21) Appl. No.: 18/791,909

(22) Filed: Aug. 1, 2024

(51) Int. Cl. G06N 20/00

(52) U.S. Cl. CPC G06N 20/00

(57) ABSTRACT

Techniques are disclosed for active adaptive on-device machine learning. An example system includes a memory having instructions, and a processor communicatively coupled to the memory and configured to execute the instructions. The instructions can include: executing a machine learning model that includes an adaptive part to output a classification result and a reconstruction of a data stream that is received for classification; using the classification result and the reconstruction of the data stream to detect changes in an environment; determining whether the changes detected in the environment are relevant; and responsive to determining that the changes are relevant, updating the adaptive part of the model.

### FIELD

Example embodiments generally relate to machine learning models and artificial intelligence. More specifically, at least some embodiments relate to systems, hardware, software, computer-readable media, and methods for application of active adaptive on-device machine learning in resource-constrained environments, such as in edge networks.

### BACKGROUND

Edge computing has emerged as a paradigm that brings computation and data storage closer to the location where it is needed, to improve response times and save bandwidth. The proliferation of Internet of Things (IoT) devices has led to an increase in generation of data at the edge, necessitating efficient processing methods that can operate within the limited resources of such devices. Machine learning (ML) models, particularly those that can be executed on-device (for example, TinyML), have been developed to enable intelligent processing at the edge. However, such ML models often face challenges such as limited memory, computational power, and energy resources, which can hinder their ability to learn and adapt over time without compromising performance.

### SUMMARY

Techniques are disclosed for active adaptive on-device machine learning.

In one embodiment, a system includes a memory having instructions, and a processor communicatively coupled to the memory and configured to execute the instructions. The instructions can include: executing a machine learning model that includes an adaptive part to output a classification result and a reconstruction of a data stream that is received for classification; using the classification result and the reconstruction of the data stream to detect changes in an environment; determining whether the changes detected in the environment are relevant; and responsive to determining that the changes are relevant, updating the adaptive part of the model.

In some embodiments, the changes in the environment are detected using a dynamically adjusted threshold. Determining whether the changes detected in the environment are relevant can include comparing aggregate prediction confidences against the dynamically adjusted threshold. The threshold can be dynamically adjusted based on a reconstruction error between the received data stream and its reconstruction. The threshold can be dynamically adjusted by adjusting the threshold using a predefined constant to control variation of the threshold based on the reconstruction error. Executing the ML model can operate in phases including, but not limited to: a model inference phase; an active on-device learning phase; and an on-device model adaptation phase. The instructions can further include, during the model inference phase, using the model to output a set of predicted labels and their respective confidences; and using the model to generate a reconstruction of the received data stream. The instructions can further include, during the active on-device learning phase, receiving aggregate confidences and a reconstruction error from the model inference phase; using the reconstruction error to dynamically adjust a threshold; and using the dynamically adjusted threshold to externalize a drift detection result. The instructions can further include, during the on-device model adaptation phase, responsive to determining that the changes are relevant during the active on-device learning phase, updating the adaptive part of the model by training a classification sub-model and a decoder sub-model of the model. The model can further include a frozen part. The system can be operable within manufacturing plants for monitoring and automating production processes. The system can be operable within a smart city infrastructure to process data from cameras, traffic lights, and smart vehicles.

Other example embodiments include, without limitation, apparatus, systems, methods, and computer program products comprising processor-readable storage media.

Other aspects will be apparent from the following detailed description and the amended claims.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

In the drawings:

FIG. 1 discloses aspects of an example training pipeline, in accordance with illustrative embodiments.

FIG. 2 discloses aspects of an example learning solution, in accordance with illustrative embodiments.

FIG. 3 discloses aspects of an example learning framework, in accordance with illustrative embodiments.

FIG. 4 discloses aspects of an example environment change detector, in accordance with illustrative embodiments.

FIG. 5 discloses aspects of an example dynamic threshold adjustment, in accordance with illustrative embodiments.

FIG. 6 discloses a flowchart of an example method, in accordance with illustrative embodiments.

FIG. 7 discloses aspects of a computing entity configured and operable to perform any of the disclosed methods, processes, and operations, in accordance with illustrative embodiments.

### DETAILED DESCRIPTION

Example embodiments generally relate to machine learning models and artificial intelligence. More specifically, at least some embodiments relate to systems, hardware, software, computer-readable media, and methods for application of active adaptive on-device machine learning in resource-constrained environments, such as in edge networks.

Disclosed herein are techniques for active adaptive on-device learning in resource-constrained environments, enabling intelligent edge devices to adapt to their environment dynamically while minimizing resource consumption and risk of overfitting.

Example embodiments provide an active on-device learning TinyML solution that is able to adapt dynamically and actively to environment changes. Considering that optimizing memory usage and energy consumption are important to provide intelligence at the extreme edge, the disclosed techniques provide an active continuous adaptation mechanism by performing timely updates.

In the realm of edge computing, the deployment of ML models on devices with stringent resource constraints, such as IoT devices and microcontrollers, has become increasingly important. Conventional approaches to ML at the edge have involved the use of static models that are trained and optimized in the cloud before being deployed to edge devices. These models, once deployed, do not adapt to changes in the data they encounter, which can lead to suboptimal performance as the environment evolves.

Conventional approaches to enabling on-device learning have included methods for updating models with every new piece of data received. While this allows for some degree of adaptability, it also leads to technical problems such as significant resource consumption and can result in model overfitting, where the model becomes overly tailored to the recent data and loses its generalization capabilities. Additionally, the constant updates require frequent storage of intermediate activations for backpropagation, further increasing the memory footprint and energy consumption.

The techniques disclosed herein address these technical problems by providing technical solutions that include an active on-device learning approach for extreme resource-constrained devices. In example embodiments, an ML model includes a frozen part that remains unchanged post-deployment, and an adaptive part that can be updated in response to changes detected in the environment.

In one implementation, an environment change detector leverages a drift detector. The drift detector uses a dynamically adjusted threshold to determine the presence of relevant environment changes. This threshold is adjusted based on a reconstruction error, which is calculated by comparing the input data stream to its reconstruction generated by the model. By dynamically adjusting the threshold, the system can more accurately detect when significant changes in the environment warrant an update to the model, thereby optimizing resource usage and reducing the likelihood of overfitting.

In one implementation, the ML model is operable in phases that include, but are not limited to, model inference, active on-device learning, and on-device model adaptation. During the model inference phase, the system processes incoming data to provide classification outputs and data reconstructions. In the active on-device learning phase, the system uses the outputs from the model inference phase to adjust the threshold and determine whether to externalize a drift detection result. If relevant changes are detected, the system proceeds to the on-device model adaptation phase, where training is performed on the classification sub-model and the decoder sub-model to adapt the model to the current environment.

The disclosed techniques also leverage a decoder layer that provides additional feedback to the environment change detector, further enhancing the ability of the system to adapt to changes.

The present system is designed to be useful in various settings, including manufacturing plants and smart city infrastructure, where it can monitor and automate processes, optimize resource usage, and decrease communication overhead with cloud infrastructure.

It is expected that in upcoming years most of the world's enterprise-generated data will exist outside of the cloud environment, requiring ML solutions to expand further into the edge, e.g., closer to the users. It is forecasted that the global edge computing market will become a trillion dollars shortly, if not already. With that in mind, enterprises can benefit from expanding solutions for different edge environments and use cases.

Edge devices can be extremely limited in resources. TinyML is a technical response for executing ML solutions on top of such resource-constrained devices and it is expected that almost 2.5 billion devices will be shipped with a TinyML chipset in 2030. In this context, different technology companies are promoting the expansion of the TinyML ecosystem by developing and offering specialized libraries, and efforts have been made to deploy ML solutions into IoT devices, due to advantages in terms of reduced latency, bandwidth connection, energy consumption, and security/privacy. Concomitantly, there are relevant companies that are interested in enabling intelligence for extreme-constrained devices and have begun to offer TinyML-as-a-Service solutions. However, conventional solutions focus on freezing the ML model entirely and rolling out new updates via cloud, or freezing the model partially and training the non-frozen portion on-device. In either case, if adaptation is required, the training is performed constantly without considering any changes in the environment, which increases model overfitting and promotes inefficient resource usage at the device.

Within this context, technical problems addressed by the disclosed techniques include, but are not limited to:
Inefficient training updates that waste device resources, e.g., inefficient resource usage, and
TinyML model overfitting in a continuous on-device learning environment

In contrast to conventional solutions that use passive adaptation mechanisms, example embodiments provide a continuous active on-device learning approach that improves the resource usage during model adaptation while also minimizing overfitting. Example embodiments couple the training process with an environment monitoring mechanism, which is responsible for evaluating the environment dynamics and orchestrating the active on-device learning process. In other words, the disclosed approach allows model updates only under relevant environment changes, which in turn, reduces the resource usage to adapt the model according to the environment dynamics. Example embodiments leverage an active on-device learning approach based on an environment change monitor, which in turn is able to adapt dynamically based on network output.

Conventional TinyML continuous on-device learning solutions are based on passive adaptation mechanisms, which increase resource utilization since training is performed for every data input. Additionally, passive adaptation mechanisms are prone to negatively impact the model's accuracy performance due to catastrophic forgetting and overfitting.

In contrast, example embodiments provide a continuous active on-device learning approach that decreases model overfitting and optimizes training times by leveraging a drift detector. Advantageously, adapting only in the presence of relevant changes in the environment reduces resource usage since less training updates will be executed.

Additionally, a feedback mechanism allows the predictions of a classifier and a decoder to affect the environment change monitor, thereby enabling the present learning system to adjust automatically according to environment dynamics.

Specific embodiments will now be described in detail with reference to the accompanying figures. In the following detailed description of example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### A. Context for an Example Embodiment

The following is a discussion of a context for example embodiments. This discussion is not intended to limit the scope of the invention, or the applicability of the embodiments, in any way.

Considering resource constraints of extreme edge devices, existing solutions typically focus on model compression and optimization of the inference process. Nonetheless, existing on-device learning approaches have also gained attention aiming at provisioning better personalization. For example, some online learning approaches provide on-device adaptation for TinyML solutions based on neural networks. However, such existing solutions are restricted to updating the model with all received input data. This conventional approach leads to the need to constantly store intermediate activations required for backpropagation, increasing memory footprint and energy consumption.

### A.1. TinyML

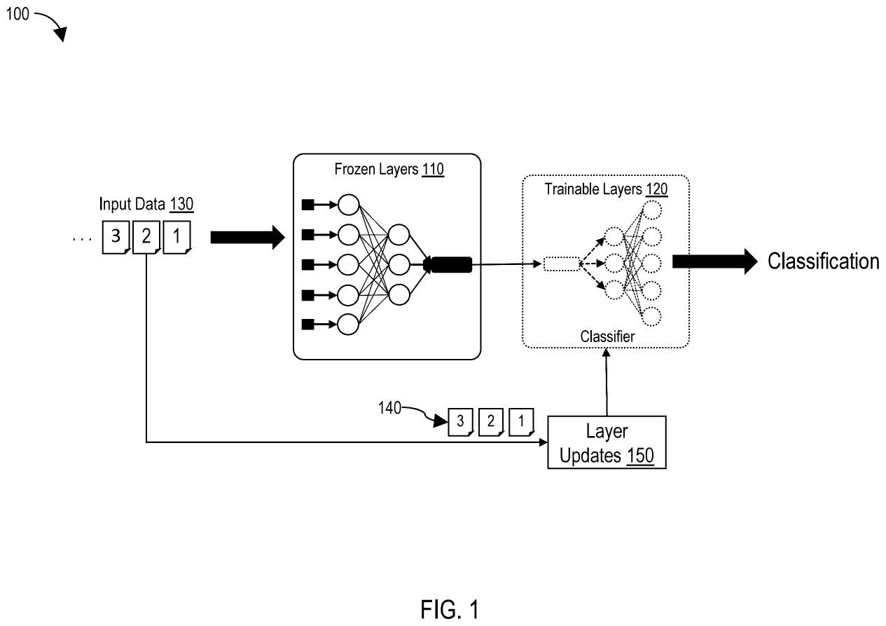

FIG. 1 shows aspects of an example training pipeline 100, in accordance with illustrative embodiments.

The spread of pervasive devices results in a demand for ML solutions at the extreme edge. Nonetheless, there can be severe constraints on memory, computation, and energy consumption that these ML solutions must abide by. TinyML comes as a response to such demand by limiting model resource usage and enabling execution on IoT devices and micro controller units. The integration of intelligence within such small devices brings a series of advantages in terms of energy efficiency, low cost, latency, system reliability and data security, making such approaches interesting to a broad range of segments, such as industry 4.0, smart cities, smart agriculture/farming, e-health, entertainment, and others.

Existing TinyML approaches rely on cloud training and optimization before deployment to support execution in such environments. Conventional TinyML approaches envision a fixed model where there is no further training after deployment in the field, e.g., the training phase depends on external resources (such as via gateways and/or cloud). Continuous training is also gaining attention, though existing approaches waste resources since they train on every unit of new data, regardless of whether any significant changes in the environment are observed.

FIG. 1 shows an overview of how TinyML solutions 100 tackle a continuous training setting. These solutions follow a similar blueprint. Parts of the model are optimized at the cloud and frozen 110, while the rest of the network is still updated during on-device training 120. Most TinyML solutions perform training 150 for every new data sample 130 which wastes precious resources and leaves the ML model prone to overfitting. FIG. 1 shows an example of this interaction by showing that all data samples 140 are used for the layer updates 150.

### A.2. Drift Detection

Lightweight solutions for drift detection are generally configured to perform statistical analysis on data samples to infer if there is a shift from the data distribution. One common approach is to use the output of a classification network. Entropy or averages values based on the network prediction confidences are learned during training to create a threshold that will work as a trigger to detect drifts from the data. Whenever drifted data comes in, it is likely that the network prediction confidences will behave differently, thereby triggering the drift detection. In such case, the threshold learned during training remains fixed, which implicitly assumes the network is static or not capable of learning drifted data.

### B. Overview of Aspects of an Example Embodiment

### B.1. Example Pipeline

Disclosed herein are techniques for model adaptation that address several limitations of conventional on-device learning solutions. Before explaining how the proposed approach works, this section introduces aspects of components used in one example implementation.

Example embodiments presume a ML model inside a device that benefits from continuous training to adapt properly to environment dynamics. The disclosed framework leverages a TinyML architecture, in which the model includes a frozen part that is not updated on-device, and an adaptive part that supports training updates. Advantageously, example embodiments include an environment monitoring mechanism that enables the creation of an active on-device learning system for highly resource-constrained devices. More particularly, the present learning solution is operable to optimize the learning process by allowing updates only under relevant environment changes.

Example embodiments extend an existing TinyML architecture to provide an active continuous learning framework that only trains with relevant input samples, thereby decreasing computational burden and improving memory efficiency. In some embodiments, the present learning solution is further configured to adjust dynamically a drift detection threshold based on additional network information, to compensate for newly learned data. Moreover, illustrative embodiments leverage the dynamic threshold drift detector to enhance the network training procedure. Advantageously, the present learning solution is configured to couple drift-detection with active continuous learning, allowing for decreased resource usage and model overfitting.

In one implementation, the present learning solution operates in three general phases, as follows:

### Phase 1: Model Inference

The first phase begins after receiving data for classification. Example steps include, but are not limited to, the following:
1. Receive a data stream (x) as input
2. The ML model outputs two distinct outputs:
   a. Classification sub-model: A set of predicted labels and their respective confidences γ
   b. Decoder sub-model: Generates a reconstruction of the input (x′)
3. Aggregate confidences into an average per class γ
4. Calculate a reconstruction error E between x′ and x

### Phase 2: Active On-Device Learning

In one implementation, during this phase, ε and γ are used to detect the presence of relevant changes in the environment and decide if it is worth adapting the model according to the current scenario. An environment monitoring mechanism is configured to use a threshold and the confidence per class to detect concept drift based on the current environment characteristics. Given an aggregate statistic over the confidences, if the value is lower than the threshold, then the present monitoring mechanism detects relevant changes in the environment and then triggers the active on-device learning process. In example embodiments, the initial threshold is initialized by using the same aggregate statistic over the confidences of the training batches at the cloud. In further embodiments, the threshold is adapted dynamically by leveraging the reconstruction error.

Below are example steps performed during this phase:
1. Receive the aggregate confidences γ and error ε from the model inference phase
2. Modify the threshold based on ε
   a. The threshold is adjusted dynamically according to the error ε between the given input and its reconstruction. It is appreciated that a high reconstruction error indicates the given input departs from the data distribution seen so far. Therefore, the threshold can be updated to increase the sensitivity of the drift detection mechanism according to changes in the environment. Similarly, a low reconstruction error can produce a lower threshold, more attainable, making the mechanism less sensitive to drift.
3. Compare the aggregate with the new threshold
4. Externalize drift detection result

### Phase 3: On-Device Model Adaptation

In example embodiments, in this phase, training is carried out in the classification sub-model and the decoder sub-model only if relevant environment changes were identified by the environment monitoring mechanism. Advantageously, this approach limits the number of times training is performed and avoids training on well-learned data, helping diminish the likelihood of model overfitting.

### B.2. Example Framework

This section provides further detail for the present learning solution. Advantageously, example embodiments improve the learning process using an active adaptive mechanism that is configured to trigger updates only under relevant environment changes.

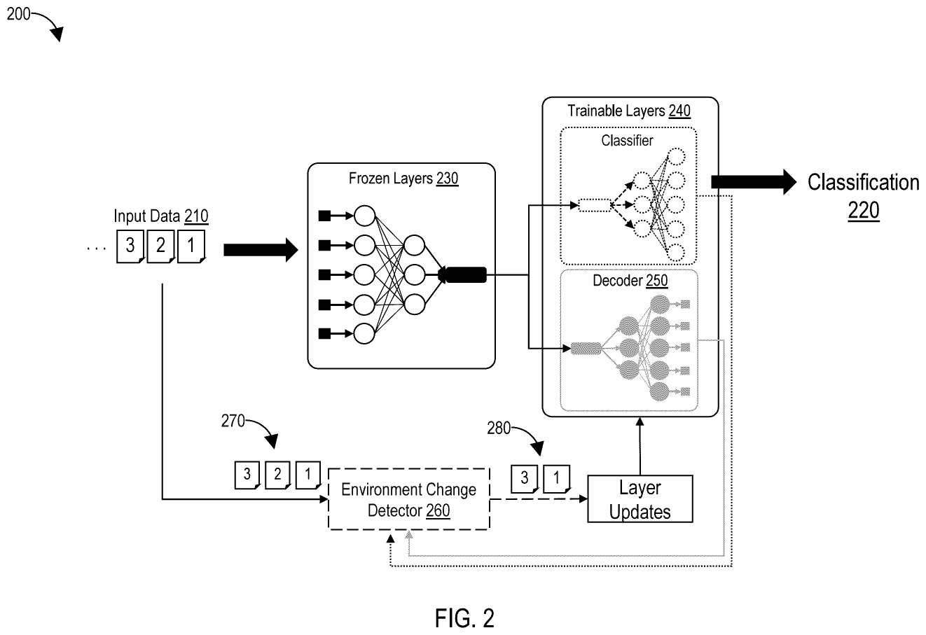

FIG. 2 shows aspects of an example learning solution 200, in accordance with illustrative embodiments. Particularly, FIG. 2 illustrates the learning solution configured to process input data 210 and generate a classification 220.

Deciding which updates to perform during on-device learning in highly constrained environments advantageously allows for optimizing resource usage and for efficiently adapting to environment dynamics. Example embodiments leverage a dynamic environment monitoring mechanism that controls updates using input data 210 and the network's output, which efficiently enables intelligence and flexibility (in terms of adaptability) for extreme resource-constrained edge devices, such as but not limited to microcontroller units and IoT devices. In summary, the present learning solution leverages an active on-device learning approach that allows for efficient continuous training at the edge while avoiding overfitting.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s), artificial intelligence device(s), or any other type of intelligent computing system. Any amount of training data may be used (and perhaps later refined) to train the machine learning algorithm to dynamically perform the disclosed operations. As discussed in further detail herein, example training data can include collected input data 210.

As mentioned, example embodiments enhance a TinyML architecture with a classification network that includes both frozen layers 230 and adaptable layers 240, and a pipeline with a pre-trained cloud optimization. FIG. 2 shows example modifications to a TinyML on-device training pipeline to support the present learning solution 200. Generally, additions to the pipeline include, but are not limited to, a trainable decoder 250 and an environment change detector module 260.

The environment change detector module 260 is configured to leverage a lightweight concept drift detection mechanism (section A.2) that is enhanced to dynamically adjust the threshold (according to environment changes) to follow the trainable layers learning. As illustrated, the environment change detector receives input data 270 that is based on input data 210. The example input data 270 can include samples including batch numbers 1-3. The environment change detector module is configured to determine which batches will be used during on-device training of the trainable layers. For example, as illustrated, the environment change detector determines that sample batch number 2 can be excluded from the output samples 280.

The trainable decoder layer 250 is configured for providing additional feedback into the environment change detector 260. The additional feedback provided is discussed in further detail herein.

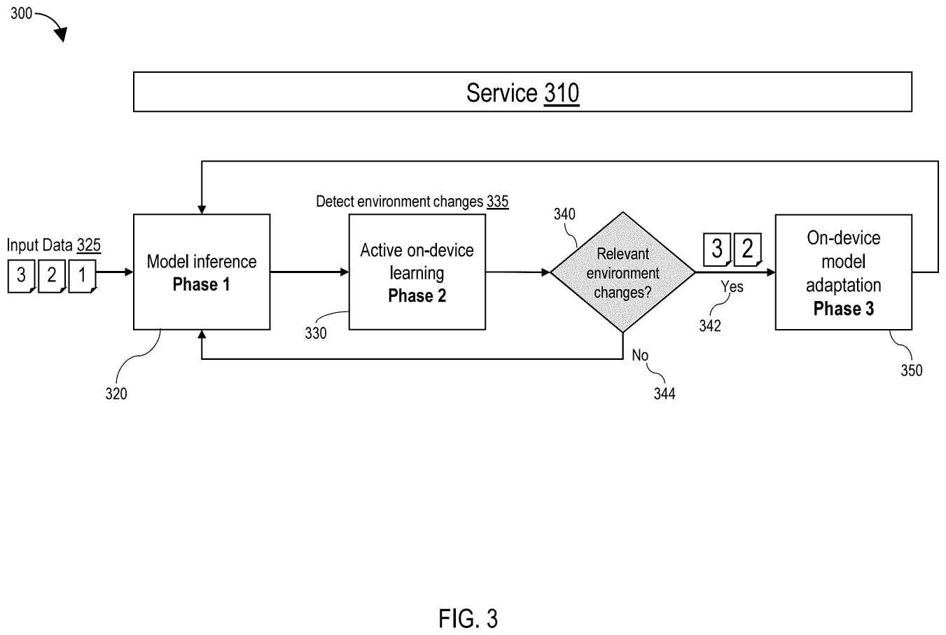

FIG. 3 shows aspects of an example learning framework 300, in accordance with illustrative embodiments.

In example embodiments, a service 310 can implement the present learning techniques. As used herein, the term “service” refers to an automated program that is tasked with performing different actions based on input. In some cases, the service can be a deterministic service that operates fully given a set of inputs and without a randomization factor. In other cases, the service can be or can include a ML or artificial intelligence engine. The ML engine enables the service to operate even when faced with a randomization factor.

In some implementations, the service 310 is a cloud service operating in a cloud environment. In some implementations, the service is a local service operating on a local device, such as a server. In some implementations, the service is a hybrid service that includes a cloud component operating in the cloud and a local component operating on a local device. These two components can communicate with one another.

FIG. 3 shows an overview of example operation of the present learning framework, which, in one implementation, is divided into the following phases:
1. In Phase 1 320 (Section C.1.1), input data 325 is received for classification. The ML model is configured to output prediction confidences per class and a reconstruction error related to the data input that will be later used to dynamically adapt the environment monitoring mechanism.
2. In Phase 2 330 (Section C.1.2), the environment change mechanism 335 is configured to detect whether model adaptation is required based on the outputs from Phase 1 320. If there are relevant changes 340 in the environment, operation 342 proceeds to Phase 3 350. Otherwise 344, Phase 3 is overridden and operation returns to Phase 1 to process the next input data batch.
3. In Phase 3 350 (Section C.1.3), on-device training is executed in order to adapt the ML model according to the current scenario.

Section C explores each phase and their associated components in further detail.

### C. Detailed Description of Aspects of an Example Embodiment

### C.1. Example Operation

TinyML models can generally be trained on the cloud and optimized for device hardware constraints. Example embodiments leverage a similar cloud pipeline with added enhancements.

In example embodiments, the network architecture leverages an additional trainable decoder-layer, which leads the network to be a double output neural network. Accordingly, training and optimization performed at the cloud uses joint-loss training configured to optimize both the classification and the decoder layers.

With reference to FIG. 3, in addition to the initial cloud participation process, example embodiments operate in three phases 320, 330, 350 at the edge device: model inference, active on-device learning, and on-device model adaptation. This section provides details on each of these phases and accompanying processes.

### C.1.1. Phase 1—Model Inference

The entry point of Phase 1 is the frozen layers, which receive input data from outside sources. Consistent with TinyML solutions, the frozen layers are fully pre-trained and optimized for execution on the device using techniques such as quantization and pruning. This approach greatly improves device resource usage since only other parts of the network will be updated.

Example steps of this phase include, but are not limited to, the following:
1. Receive a data stream (x) as input from an outside module or source
2. Feed the data into the network
3. Output the classification prediction, prediction confidences, and the decoder reconstruction

In example embodiments, the data stream (x) initially passes over the frozen layers and is carried onto the trainable layers. The trainable layers are configured for providing the data reconstruction (x′) via decoder trainable layer and the data classification plus the prediction confidences via classification trainable layer.

### C.1.2. Phase 2—Dynamic Active On-Device Learning

In Phase 2, an environment change detector module orchestrates an active adaptation mechanism leveraging an unsupervised lightweight drift detection mechanism.

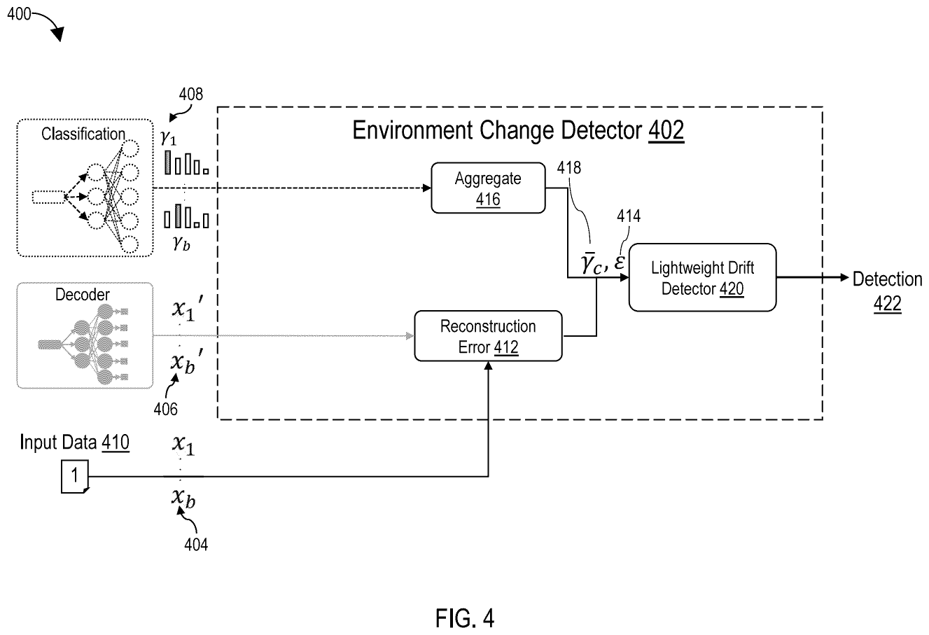

FIG. 4 shows an overview 400 of an example environment change detector 402, in accordance with illustrative embodiments. The environment change detector 402 is one example of the environment change detector 260 (FIG. 2). In particular, the environment change detector receives the input data x 404, the reconstructed data x′ 406, and the predicted confidence values 408 for the current samples 410 within the batches.

FIG. 4 shows batch number 1 410 being received with b samples. In example embodiments, the reconstruction error ε 414 is measured 412 by calculating the error between the input x 404 and the reconstruction x′ 406. In some implementations, the reconstruction error is calculated similarly to loss functions such as those used by autoencoders. The prediction confidences 408 are aggregated 416 via aggregated statistics for similar classes. The resulting values include an aggregate confidence score γ̅_{c} 418 that represents an aggregate prediction of all samples of the current batch for each available class (subscript c). Example embodiments feed these values 414, 418 into a lightweight drift detector 420 to determine whether there is any environment change 422.

### C.1.2.1. Dynamic Threshold Adjustment

In example embodiments, after preprocessing the received outputs from the classification and decoder layers, based on γ̅_{c} and ε, the environment change detector module is configured to identify whether there are relevant changes in the environment using a lightweight drift detector. The environment change detector will further aggregate γ̅_{c} into a value γ̅. If an average is considered as the aggregate statistic, then γ̅ represents the average confidence score of all samples in the current input batch for all available classes combined.

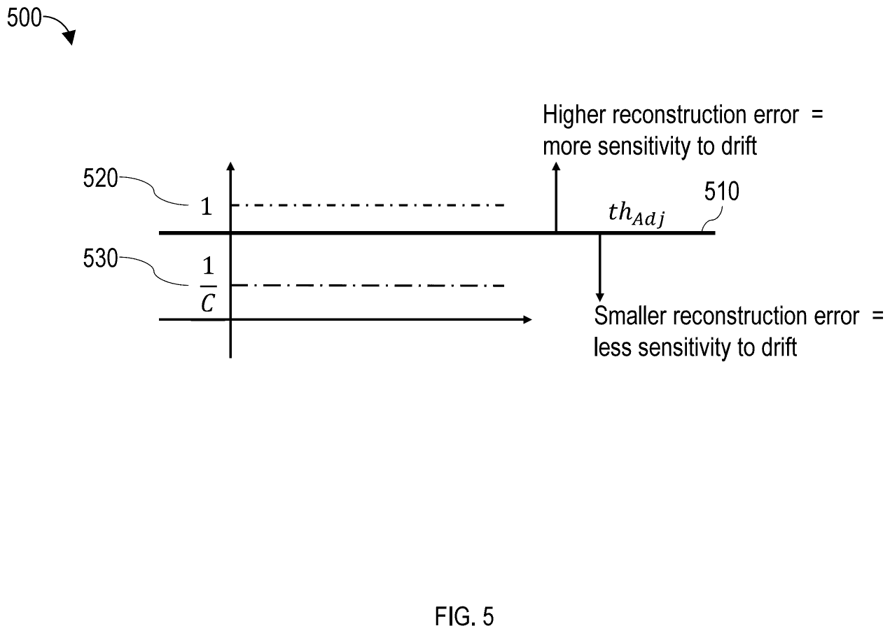

FIG. 5 shows aspects of an example dynamic threshold adjustment 500, in accordance with illustrative embodiments. In example embodiments, the dynamic threshold adjustment can be performed using the lightweight drift detector 420 (FIG. 4).

Conventionally, γ̅ would be compared to a static threshold defined during training at the cloud. However, it is appreciated that a proper threshold definition directly impacts general drift detection performance and would benefit from accounting for new learned patterns from the network.

Accordingly, example embodiments accordingly dynamically adjust the threshold using the error 414 (FIG. 4) from the decoder reconstruction. In one implementation, the threshold is adjusted using the following equation:

$$t {h}_{Adj} = {( ε )}^{α} \cdot {th}_{T r a i n} \qquad ( Eq . l )$$

where α represents a user-defined constant that limits the threshold variation, th_{Adj} represents the dynamic threshold 510 for the current batch, and th_{Train} represents the static threshold learned during training at the cloud.

Generally, the reconstruction error ε represents the distance between the given input and its reconstruction. Intuitively, a high reconstruction error indicates the given input departs from the data distribution seen so far. In such a scenario, the environment change detector module dynamically updates the threshold in order to increase the sensitivity to changes in the environment. Similarly, a low reconstruction error is expected to produce a lower threshold, more attainable, making the mechanism less sensible to detect environment changes.

With reference to FIGS. 4 and 5, the illustrated adjustment 500 shows aspects of example dynamic threshold behavior according to the reconstruction error 414. The disclosed dynamic threshold adaptation can be easily adapted to support any drift detector 420 that relies on a threshold or uses prediction confidence levels, without departing from the scope of the example embodiments.

The bounds and intuition behind the threshold equation (Eq. 1) are as follows. In one implementation, given the aggregated confidence score and the reconstruction error, the environment change detector module is configured to adjust the training confidence score according to Eq. 1. For ease of illustration, consider C as the number of classes available for prediction in the classification network in the trainable layers. Both the base and dynamic threshold are defined within

$$\frac{1}{C} \leq t {h}_{Adj} \leq 1 .$$

The threshold upper bound 520 is straightforward since there is no case as over 100% confidence in prediction. The lower bound 530 considers the worst case where the classifier is fully undecided and every prediction in the batch has the worst possible confidence which means each class has the same confidence score, 1/C. Both extremes would result in the drift detector 420 being unfit for its intended purpose, considering that the drift detector would always predict relevant changes or no changes for all scenarios, depending on the extreme. Accordingly, α is provided as a fine-tunable parameter that further controls the threshold to avoid reaching such extremes.

In one implementation, after the threshold is adapted for the current data batch the drift detector performs the following comparison:

$$d = \{ \begin{matrix}1 , & \overline{γ} < t {h}_{Adj} \\ 0 , & otherwise\end{matrix}$$

In example embodiments, if d=1, this indicates there are relevant changes in the environment and the model should be adapted, e.g., proceed to Phase 3 (section C.1.3). If d=0, this indicates there are no significant changes in the current data stream and the environment change monitoring module saves energy and computing resources by returning to Phase 1 (section C.1.1).

### C.1.3. Phase 3—On-Device Model Adaptation

In example embodiments, during phase 3 the environment change detector and the layer update module are configured to orchestrate the process to adapt both networks in the trainable layers in case of relevant changes in the environment. Particularly, during this phase, the environment change detector is configured to use the result from the drift detection to forward the data batches and loss values to the layer update module. The layer update module is configured for carrying out the training algorithm within the trainable layers with respect to the selected data batches.

In some implementations, at the cloud, a joint loss is used to train the entire network as one, however now the networks are separated. Advantageously, decoupling the networks allows the developer to either continue with the joint training or leverage specific loss functions for the decoder and the classifier.

### C.2. Example Execution

This section provides example steps, in one implementation, for an execution overview of the present learning solution.
1. Receive a data stream (x) as input from an outside module or source
2. Feed the data into the network
3. Output the classification prediction, prediction confidences, and the decoder reconstruction
4. The environment change detector is configured to aggregate the prediction confidences and calculate the reconstruction error
5. The environment change detector is configured to call a lightweight drift detector using the prediction confidence scores and to dynamically adjust the threshold using the reconstruction error
   a. If relevant changes are detected in the environment: the environment change monitoring triggers the model adaptation and starts training the decoder and classifier
   b. Otherwise (e.g., if no relevant changes are detected), then the batch is not used for training, and operation returns to step 1

In one implementation, the environment change monitoring module generally provides the present on-device active adaptation mechanism, by which only meaningful updates are pushed to the trainable layers, advantageously decreasing overfit likelihood, improving prediction on unseen data, and decreasing communication overhead. It is appreciated that these are useful factors in support of TinyML and edge deployments.

More particularly, the reduction in communication overhead generally arises from less frequent model updates and communication with the cloud, since training is performed on-device, and only control information can be exchanged, if at all.

Further, the possibility of overfitting generally decreases since the trainable layers will likely be training only on new data that diverges from the training set. Moreover, in the case of highly dynamic environments where the drift patterns are frequent, the networks will iteratively adapt to the patterns until there are no significant changes in the environment. This in turn helps adaptively drive a lower reconstruction error from the decoder, and dynamically adapt the drift detector threshold accordingly, thus decreasing training occurrences even further.

The modest additional computational burden of constantly checking for environment changes is offset by improved adaptability of the model in field data and the alleviated demand for model updates.

### D. Example Methods

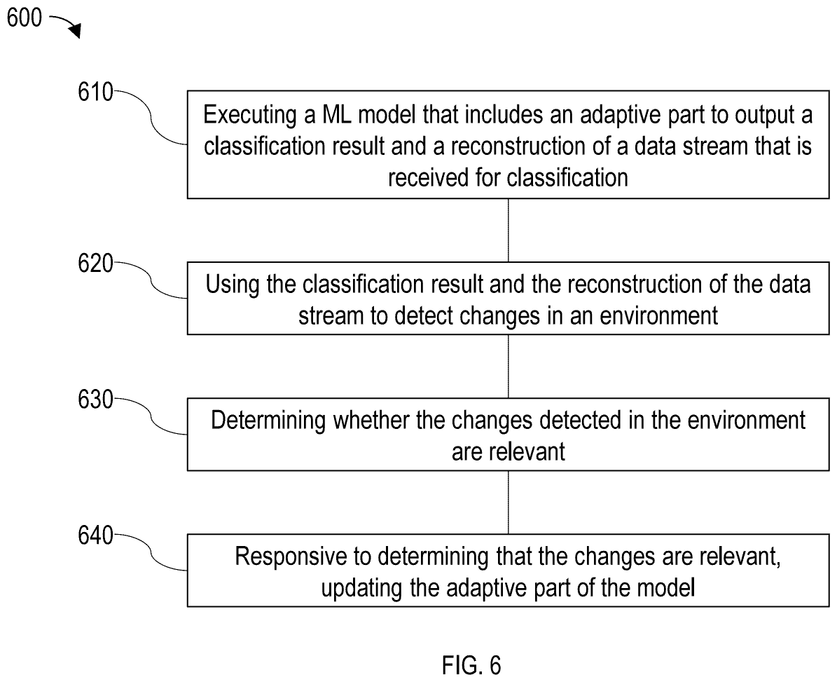

FIG. 6 shows a flowchart of an example method 600, in accordance with illustrative embodiments. In example embodiments, the method 600 allows for improved issue handling by identifying similar historical issues as references for a given issue.

In some embodiments, the method 600 can be performed by the learning solution 300, such as using the service 310.

In example embodiments, the method 600 includes executing a ML model that includes an adaptive part to output a classification result and a reconstruction of a data stream that is received for classification (step 610). In illustrative embodiments, the model further includes a frozen part. In some embodiments, executing the ML model operates in phases. Example phases include, but are not limited to, a model inference phase, an active on-device learning phase, and an on-device model adaptation phase. In one implementation, during the model inference phase the method further includes using the model to output a set of predicted labels and their respective confidences, and using the model to generate a reconstruction of the received data stream. In one implementation, during the active on-device learning phase the method further includes receiving aggregate confidences and a reconstruction error from the model inference phase, using the reconstruction error to dynamically adjust a threshold, and using the dynamically adjusted threshold to externalize a drift detection result. In one implementation, during the on-device model adaptation phase the method further includes, responsive to determining that the changes are relevant during the active on-device learning phase, updating the adaptive part of the model by training a classification sub-model and a decoder sub-model of the model.

In example embodiments, the method 600 includes using the classification result and the reconstruction of the data stream to detect changes in an environment (step 620). In some embodiments, the changes in the environment are detected using a dynamically adjusted threshold. In some embodiments, the threshold is dynamically adjusted based on a reconstruction error between the received data stream and its reconstruction. In one implementation, the threshold is dynamically adjusted by adjusting the threshold using a predefined constant to control variation of the threshold based on the reconstruction error.

In example embodiments, the method 600 includes determining whether the changes detected in the environment are relevant (step 630). In some embodiments, determining whether changes detected in the environment are relevant includes comparing aggregate prediction confidences against a dynamically adjusted threshold.

In example embodiments, the method 600 includes, responsive to determining that the changes are relevant, updating the adaptive part of the model (step 640). In some embodiments, the method further includes, responsive to determining that the changes detected in the environment are not relevant, refraining from updating the adaptive part of the model.

In some embodiments, the method operates within manufacturing plants for monitoring and automating production processes. In some embodiments, the method operates within a smart city infrastructure to process data from cameras, traffic lights, and smart vehicles.

While the various steps in the example method 600 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example method 600 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### E. Example Use Cases

This section provides example use cases related to manufacturing plants and smart cities, for ease of illustrating sample usage of the disclosed techniques. The scope of the example embodiments is not limited to the example use cases discussed in this section.

### E.1. Manufacturing Plants

In manufacturing plants, distributed edge nodes with heterogenous resource constraints are configured to coordinate the operation of several operational devices including sensors (e.g., temperature, vibration, humidity, images, position, pressure) and actuators (e.g., conveyor belts, motors) to monitor and automate the production process. The sensing units provide data about the environment and operation conditions so the edge compute nodes can monitor and assess if the production process is running as prescribed. Expansion of conventional ML intelligence solutions to resource-constrained edge devices to provide timely response in case of unexpected operation is fundamental to reduce production downtime and improve productivity.

However, the distributed and ever-changing nature of manufacturing sites must be accounted for properly. For example, it will be beneficial for manufacturing sites to provide means to address data drift that may occur due to varying data acquisition conditions. A frozen model previously trained at the cloud will not be able to properly deal with such dynamic environments, thereby reducing the effectiveness and ability of ML solutions to deliver value to the manufacturing process.

The present active on-device learning approach for extreme resource-constrained devices is an outstanding fit to handle the dynamicity encountered in manufacturing plants. Advantageously, the disclosed solution provides adaptation capability to the ML-model running in the field, while being lightweight in terms of computation and memory. Thus, the present techniques are well suited to resource-constrained setups. Owing to the active adaptation, triggered only when observing significant change in the environment, the present solution prevents wasting resources and is less prone to catastrophic forgetting and overfitting. These properties can be particularly helpful for efficiently employing ML models in extreme resource constrained sensing units.

### E.2. Smart Cities

An example smart cities use case may leverage in-situ enterprise gateways and sensors to process data within, for example, cameras, traffic lights, and smart vehicles. Such a smart city's dynamic environment poses a significant challenge for conventional ML solutions since the ever-changing environment consistently forces the network to take in as input data representing numerous differing data distributions.

Conventional approaches rely on frozen optimized models that are updated via cloud infrastructure. However, several devices are battery-dependent and may require to be updated only on high battery or during charging. In this regard a few solutions deploy conventional TinyML algorithms; however, such conventional solutions mostly perform passive training, degrading model performance due to overfitting and wasting precious resources.

Advantageously, the disclosed active on-device learning approaches can provide extended battery life by optimizing training updates and improving model learning by choosing the most meaningful samples to be trained on. Moreover, the present solution greatly limits communication with cloud since such cloud communication can be extremely energy consuming.

### F. Example Processing Platforms

At least portions of the present learning system can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the present learning system. For example, containers can be used to implement respective processing devices providing compute and/or storage services of a cloud-based system. Again, containers may be used in combination with other virtualization infrastructure such as virtual machines implemented using a hypervisor.

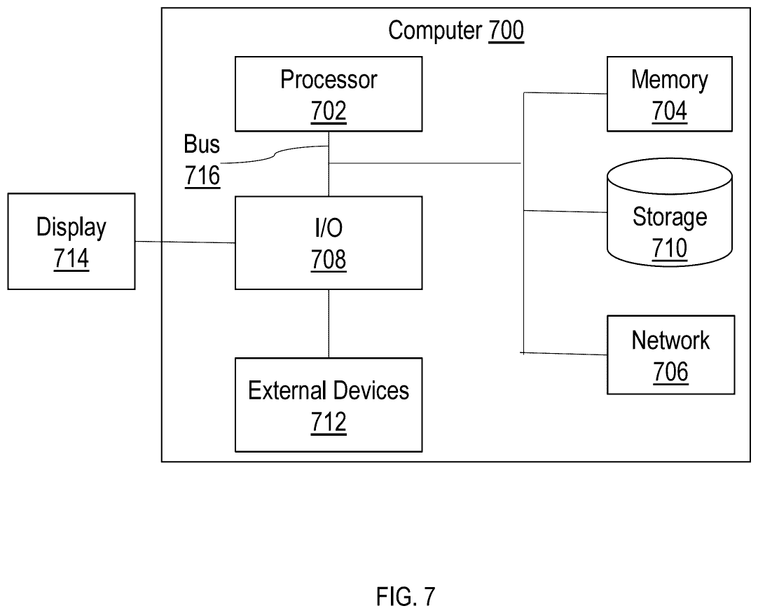

Illustrative embodiments of processing platforms will now be described in greater detail with reference to FIG. 7. Although described in the context of the present learning system, these platforms may also be used to implement at least portions of other information processing systems in other embodiments.

FIG. 7 illustrates aspects of a computing device or a computing system, in accordance with example embodiments. The computer 700 is shown in the form of a general-purpose computing device. Components of the computer may include, but are not limited to, one or more processors or processing units 702, a memory 704, a network interface 706, and a bus 716 that communicatively couples various system components including the system memory and the network interface to the processor.

The bus 716 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 700 typically includes a variety of computer-readable media. Such media may be any available media that is accessible by the computer system, and such media includes both volatile and non-volatile media, removable and non-removable media.

The memory 704 may include computer system readable media in the form of volatile memory, such as random-access memory (RAM) and/or cache memory. The computer system may further include other removable/non-removable, volatile/non-volatile computer system storage media. By way of example only, the storage system 710 may be provided for reading from and writing to a non-removable, non-volatile magnetic media (not shown and typically called a “hard drive”) in accordance with the present learning techniques. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 716 by one or more data media interfaces. As has been depicted and described in connection with FIGS. 1-6, the memory may include at least one computer program product having a set (e.g., at least one) of program modules that are configured to carry out the functions of the embodiments as described herein.

The computer 700 may also include a program/utility, having a set (at least one) of program modules, which may be stored in the memory 704 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 700 may also communicate with one or more external devices 712 such as a keyboard, a pointing device, a display 714, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 708. Still yet, the computer system may communicate with one or more networks such as a local area network (LAN), a general wide area network (WAN), and/or a public network (e.g., the Internet) via the network adapter 706. As depicted, the network adapter communicates with the other components of the computer system via the bus 716. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1-7, any component described with regard to a figure, in various embodiments of the invention, may be equivalent to one or more like-named components described with regard to any other figure. For brevity, descriptions of these components has not been repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.” This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the embodiments described herein should be limited only by the appended claims.

What is claimed is:

1. A system comprising:
a memory including instructions; and
a processor communicatively coupled to the memory and configured to execute the instructions, the instructions including:
executing a machine learning (ML) model that includes an adaptive part to output a classification result and a reconstruction of a data stream that is received for classification;
using the classification result and the reconstruction of the data stream to detect changes in an environment;
determining whether the changes detected in the environment are relevant; and
responsive to determining that the changes are relevant, updating the adaptive part of the model.

2. The system of claim 1, wherein the changes in the environment are detected using a dynamically adjusted threshold.

3. The system of claim 2, wherein determining whether the changes detected in the environment are relevant includes comparing aggregate prediction confidences against the dynamically adjusted threshold.

4. The system of claim 2, wherein the threshold is dynamically adjusted based on a reconstruction error between the received data stream and its reconstruction.

5. The system of claim 4, wherein the threshold is dynamically adjusted by adjusting the threshold using a predefined constant to control variation of the threshold based on the reconstruction error.

6. The system of claim 1, wherein executing the ML model operates in phases including:
a model inference phase;
an active on-device learning phase; and
an on-device model adaptation phase.

7. The system of claim 6, wherein the instructions further include:
during the model inference phase:
using the model to output a set of predicted labels and their respective confidences; and
using the model to generate a reconstruction of the received data stream.

8. The system of claim 6, wherein the instructions further include:
during the active on-device learning phase:
receiving aggregate confidences and a reconstruction error from the model inference phase;
using the reconstruction error to dynamically adjust a threshold; and
using the dynamically adjusted threshold to externalize a drift detection result.

9. The system of claim 6, wherein the instructions further include:
during the on-device model adaptation phase:
responsive to determining that the changes are relevant during the active on-device learning phase, updating the adaptive part of the model by training a classification sub-model and a decoder sub-model of the model.

10. The system of claim 1, wherein the instructions further include:
responsive to determining that the changes detected in the environment are not relevant, refraining from updating the adaptive part of the model.

11. The system of claim 1, wherein the model further includes a frozen part.

12. The system of claim 1, wherein the system is operable within manufacturing plants for monitoring and automating production processes.

13. The system of claim 1, wherein the system is operable within a smart city infrastructure to process data from cameras, traffic lights, and smart vehicles.

14. A method comprising:
executing a machine learning (ML) model that includes an adaptive part to output a classification result and a reconstruction of a data stream that is received for classification;
using the classification result and the reconstruction of the data stream to detect changes in an environment;
determining whether the changes detected in the environment are relevant; and
responsive to determining that the changes are relevant, updating the adaptive part of the model.

15. The method of claim 14, wherein the changes in the environment are detected using a dynamically adjusted threshold.

16. The method of claim 15, wherein determining whether the changes detected in the environment are relevant includes comparing aggregate prediction confidences against the dynamically adjusted threshold.

17. The method of claim 15, wherein the threshold is dynamically adjusted based on a reconstruction error between the received data stream and its reconstruction.

18. The method of claim 17, wherein the threshold is dynamically adjusted by adjusting the threshold using a predefined constant to control variation of the threshold based on the reconstruction error.

19. The method of claim 14, wherein executing the ML model operates in phases including:
a model inference phase;
an active on-device learning phase; and
an on-device model adaptation phase.

20. A non-transitory processor-readable storage medium having stored thereon program code of one or more software programs, wherein the program code when executed by at least one processing device causes the at least one processing device to perform the following steps:
executing a machine learning (ML) model that includes an adaptive part to output a classification result and a reconstruction of a data stream that is received for classification;
using the classification result and the reconstruction of the data stream to detect changes in an environment;
determining whether the changes detected in the environment are relevant; and
responsive to determining that the changes are relevant, updating the adaptive part of the model.
